(19) United States
(12) Patent Application Publication
(10) Pub. No.: US 2024/0086706 A1
(43) Pub. Date: Mar. 14, 2024

(54) STORAGE MEDIUM, MACHINE LEARNING METHOD, AND MACHINE LEARNING DEVICE

(71) Applicant: FUJITSU LIMITED, Kawasaki-shi (JP)

(72) Inventor: Ryosuke SONODA, Yokohama (JP)

(73) Assignee: FUJITSU LIMITED, Kawasaki-shi (JP)

(21) Appl. No.: 18/515,847

(22) Filed: Nov. 21, 2023

Related U.S. Application Data
(63) Continuation of application No. PCT/JP2021/021059, filed on Jun. 2, 2021.

(51) Int. Cl. G06N 3/08

(52) U.S. Cl. CPC G06N 3/08

(57) ABSTRACT

A storage medium storing an information processing program that causes a computer to execute processing that includes specifying a first order of a rank in data that is descending order of an output of a machine learning model, the output being an impact of the data on a certain event; specifying a second order by interchanging the rank of first data that includes a first value of a binary parameter and second data that includes a second value among the data in the first order, the first data being opposite to the second data of a positive example or negative example for the output, a difference of a value of function after interchanging being less than a value of function before interchanging; acquiring a parameter weighted based on the second order; and training the machine learning model by using a loss function including the parameters.

### CROSS-REFERENCE TO RELATED APPLICATION

This application is a continuation application of International Application PCT/JP2021/021059 filed on Jun. 2, 2021 and designated the U.S., the entire contents of which are incorporated herein by reference.

### FIELD

The present invention relates to a storage medium, a machine learning method, and a machine learning device.

### BACKGROUND

In recent years, rank learning has been known, in which a ranking arranged in descending order of likelihood of being a positive example is predicted using a machine learning model, from past binary data such as click on a web page, credit, acceptance of adoption, and the like.

Rank learning has been used for decision-making by many companies such as banks and SNS (Social Networking Service) companies.

However, there are cases in which attributes that must not be distinguished (protection attributes), such as gender and race, affect prediction results, which is problematic. Such a problem has been proposed in the classification problem before, but has also been proposed in the ranking problem in recent years.

For example, in the SNS, by performing machine learning using data in which the number of clicks of a male account is large, there is a case where it is predicted that the male account occupies the top of the search result ranking.

The main reason for this is that input data used in machine learning includes a differential bias. In the above example, the cause is data in which the number of positive male cases is overwhelmingly large or data in which the number of males is overwhelmingly large.

For ranking of prediction results, various criteria are introduced to evaluate the fairness of groups based on protection attributes (protection groups), and fair rank learning is expected to take into account potential social issues such as discrimination and to remove bias from the output.

As a method for correcting such unfairness of ranking output, an in-processing method is known in which fairness correction processing is performed by adding a fairness constraint to an AI (Artificial Intelligence)algorithm of rank learning. In such a method, as described in the following equation (1), a fairness constraint is added to the loss, and its approximate equation is optimized.

[Equation 1]

Loss=−Σ_{(y}_{ᵢ}_{,y}_{ⱼ}_{)∈D}_{_{biased}}{P(ŷᵢ>yⱼ|yᵢ>yⱼ)+λᵢⱼ(|A_{G}_{ᵢ}_{>G}_{ⱼ}−A_{G}_{ᵢ}_{>G}_{ⱼ}|−ε)} Equation(1)
ACCURACY LOSS: P(ŷᵢ>ŷⱼ|yᵢ>yⱼ)
FAIRNESS CONSTRAINT: λᵢⱼ(|A_{G}_{ᵢ}_{>G}_{ⱼ}−A_{G}_{ᵢ}_{>G}_{ⱼ}|−ε)

The tolerance ε is a threshold value at which unfairness is allowed, and λij is a parameter for controlling the influence of the constraint.

In machine learning, a loss function represented by Equation (1) above An optimization problem that minimizes Loss is solved.

### CITATION LIST

### Patent Document

[Patent Document 1] International Publication Pamphlet No. WO 2020/240981
[Patent Document 2] U.S. Patent Application Publication No. 2020/0293839

### SUMMARY

According to an aspect of the embodiments, an non-transitory computer-readable storage medium storing an information processing program that causes at least one computer to execute processing, the process includes specifying a first order of a rank in a plurality of pieces of data that is descending order of an output of a machine learning model, the output being an impact of the plurality of pieces of data on a certain event; specifying a second order by interchanging the rank of first data that includes a first value of a binary parameter and second data that includes a second value of the binary parameter among the plurality of pieces of data in the first order, the first data being opposite to the second data of a positive example or negative example for the output, a difference of a value of function after interchanging being less than a value of function before interchanging; acquiring a parameter weighted based on the second order; and training the machine learning model by using a loss function including the parameters.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a functional configuration of an information processing apparatus as an example of an embodiment;

FIG. 2 is a diagram showing an example in which ranking is set for a plurality of examples according to prediction scores;

FIG. 3 is a diagram for explaining swap variables in the information processing apparatus as an example of the embodiment;

FIG. 4 is a flowchart for explaining processing in the information processing apparatus as an example of the embodiment;

FIG. 5 is a diagram showing a fairness evaluation value by the information processing apparatus as an example of the embodiment in comparison with a conventional method;

FIG. 6 is a diagram illustrating a fairness correction method by the information processing apparatus as an example of the embodiment in comparison with a method not considering pairs; and

FIG. 7 is a diagram illustrating a hardware configuration of an information processing apparatus as an example of the embodiment.

### DESCRIPTION OF EMBODIMENTS

In such conventional ranking output unfairness correction techniques, the fairness constraint in equation (1) above is not differentiable and needs to be approximated. This may overestimate (underestimate) the fairness. Also, when optimizing the approximated fairness constraint, it is necessary to adjust by adding a slack (small amount) because the derivative becomes 0 in many regions. This is because when less training data is available, there is a possibility that overfitting will occur and the test will fail to trade off. That is, in the optimization with the fairness constraint of the ranking accuracy loss according to the conventional method, there is a case where overfitting occurs.

In one aspect, it is an object of the present invention to enable fairness constrained optimization to be achieved without causing overfitting.

According to one embodiment, fairness constrained optimization can be achieved without causing overfitting.

Hereinafter, embodiments according to the present machine learning program, machine learning method, and machine learning device will be described with reference to the drawings. However, the embodiments described below are merely examples, and there is no intention to exclude various modifications and applications of techniques that are not explicitly described in the embodiments. That is, the present embodiment can be modified in various ways without departing from the scope of the present embodiment. In addition, each drawing is not intended to include only components illustrated in the drawing, may include other functions and the like.

(A) Configuration

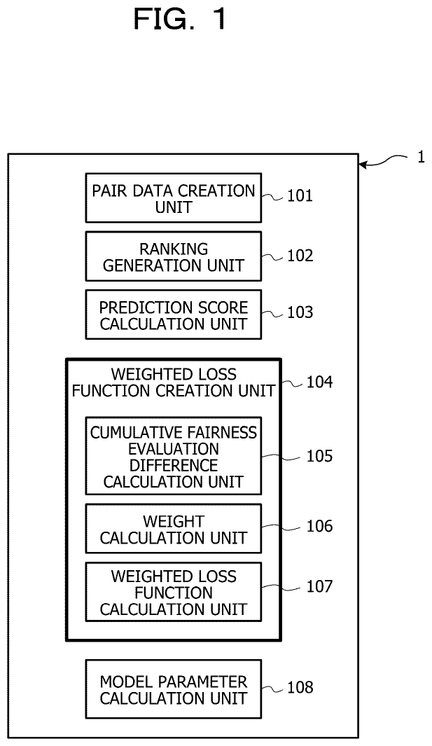

FIG. 1 is a diagram schematically illustrating a functional configuration of an information processing apparatus 1 as an example of an embodiment.

The information processing apparatus 1 ranks a plurality of (N) pieces of input data to be input. The information processing apparatus may be referred to as a computer or a calculation apparatus.

In the information processing apparatus 1, it is assumed that there is true data that cannot be observed and is not biased, but input data that can be observed is biased therefrom, so that an unfair ranking is generated. True data cannot be used, and ranking estimation is performed only from observation data in the information processing apparatus 1. In addition, group fairness is considered rather than individual fairness.

There are a plurality of ranking accuracy and fairness evaluation criteria, and in particular, it is necessary to consider a plurality of fairness evaluation criteria socially.

In the information processing apparatus 1, the following relationship is assumed between a true label which is not observed and a label which is observed. That is, it is assumed that the label y′ belonging to the true dataset Dₜᵣᵤₑ and the label y belonging to the observation dataset D_{biased} have the following binomial relationship.

P(y)∝P(y′)×w

where wε[0,1] is the bias for the true label y′. The bias is different for each group.

In machine learning, training is performed using observation data as training data. In addition, it is assumed that unfairness occurs in the specific group by inputting the label y affected by the bias to the machine learning model. The machine learning model may be simply referred to as a model (e.g., “Artificial neural network”, “ANN”, “neural network”, “neural net”, “NN”, or the like).

As illustrated in FIG. 1, the information processing apparatus 1 includes a pair data creation unit 101, a ranking generation unit 102, a prediction score calculation unit 103, a weighted loss function creation unit 104, and a model parameter calculation unit 108.

The pair data creation unit 101 creates pair data by using the input binary input data. The input data is binary data including a positive example and a negative example related to the label. The number of pieces of input data is set to N, and may be expressed as N examples. The pair data creation unit 101 creates pair data in which positive examples and negative examples are combined. Specifically, the pair data creation unit 101 creates a number of pair data equal to (the number of positive examples)×(the number of negative examples).

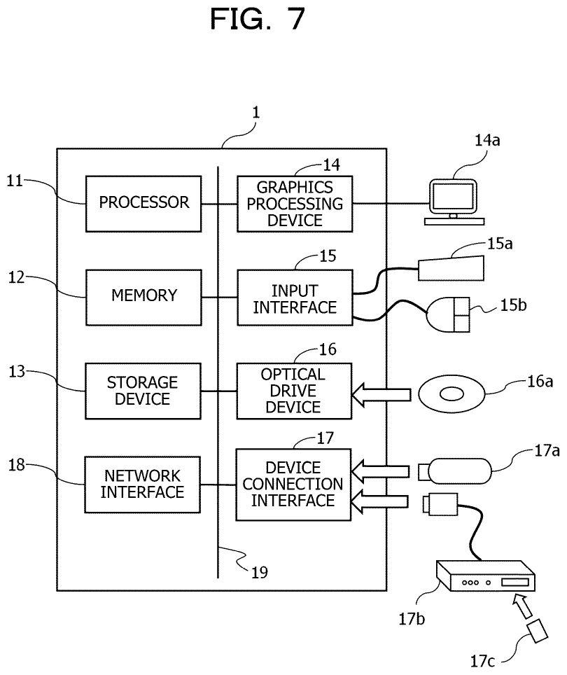

The pair data created by the pair data creation unit 101 is stored in a predetermined storage area in the memory 12 or the storage device 13 described later with reference to FIG. 7, for example.

The prediction score calculation unit 103 inputs the input data to the machine learning model and calculates a prediction score for the label {0,1}. The prediction score for example i may be represented by the following symbols: The higher the value of the prediction score (probability) determined to be a positive example. A machine learning model used in known rank learning may be used to calculate the prediction score.

ŷᵢ∈[0,1] [Equation 2]

The prediction score calculation unit 103 may use all the pair data items generated by the pair data creation unit 101. In addition, when the number of pair data items created by the pair data creation unit 101 is large and the number of pair data items is equal to or greater than a predetermined threshold value, a predetermined number of pair data items may be extracted.

The ranking generation unit 102 generate a descending order list related to the prediction scores of the examples by sorting the prediction scores of the respective examples calculated by the prediction score calculation unit 103. The descending list of prediction scores may be referred to as a prediction ranking.

The weighted loss function creation unit 104 creates a weighted loss function including weights used without performing approximation processing on the fairness constraint.

As illustrated in FIG. 1, the weighted loss function creation unit 104 includes a cumulative fairness evaluation difference calculation unit 105, a weight calculation unit 106, and a weighted loss function calculation unit 107.

The cumulative fairness evaluation difference calculation unit 105 calculates the fairness evaluation difference (diff) for each protection group pair with respect to the predicted ranking set by the ranking generation unit 102. Further, the fairness evaluation difference (diff) indicates current fairness. The cumulative fairness evaluation difference calculation unit 105 calculates a cumulative fairness evaluation difference by accumulating the fairness evaluation differences (diff) calculated for each training step. For each step of training, a process of inputting training data to the machine learning model and updating a parameter of the machine learning model based on a loss function according to the obtained prediction ranking is executed.

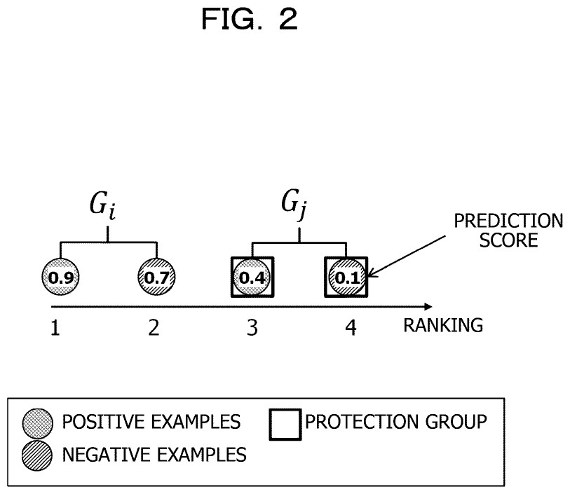

FIG. 2 is a diagram illustrating an example in which ranking is set for a plurality of examples (four examples in the example illustrated in FIG. 2) in accordance with prediction scores. In FIG. 2, a shaded circle represents a positive example or a negative example, and a number in a circle represents a prediction score.

In addition, in the drawing, a circle surrounded by a square indicates, for example, belonging to a socially minority group. A socially minority group may be referred to as a protection group. On the other hand, a circle that is not surrounded by a square indicates, for example, that a person belongs to a socially major group. A socially major group may be referred to as an unprotected group.

In the four examples illustrated in FIG. 2, ranking is set according to prediction score. In addition, a positive example with a prediction score of 0.9 and a negative example with a prediction score of 0.7 belong to the same group Gi. In addition, a positive example having a prediction score of 0.4 and a negative example having a prediction score of 0.1 belong to the same group Gj.

Hereinafter, a combination of groups may be referred to as a group pair. In the example illustrated in FIG. 2, for the group Gi, Gj, there may be, for example, four group pairs (Gi, Gi), (Gi, Gj), (Gj, Gi), (Gj, Gj).

The cumulative fairness evaluation difference calculation unit 105 calculates the difference in the fairness evaluation function for each group pair diff. The difference in the fairness evaluation function may be referred to as a difference in fairness. The difference between the fairness evaluation functions represents the current fairness.

The cumulative fairness evaluation difference calculation unit 105 may calculate the difference diff of the fairness evaluation function by using an evaluation reference value E which is a listwise (Listwise) evaluation reference, for example.

The cumulative fairness evaluation difference calculation unit 105 calculates the evaluation reference value E_{GI} of the group G_{I} using, for example, the following equations (2) to (4).

$$[ Equation 3 ]$$

$${v}_{i} := \frac{1}{log ( {rank}_{i} + 1 )} \qquad EQUATION ( 2 )$$

$$E = \frac{{\sum }_{i} {y}_{i} {v}_{i}}{max E} \qquad EQUATION ( 3 )$$

$${E}_{{G}_{i}} := \frac{{\sum }_{i ∈ {G}_{i}} {v}_{i}}{{\sum }_{{i}^{′}} {v}_{{i}^{′}}} \qquad EQUATION ( 4 )$$

rankᵢ∈ [symbol] : PLACE IN RANKING OF EXAMPLE i
maxE: NORMALIZATION CONSTANT (THEORETICAL UPPER LIMIT OF E)

The cumulative fairness evaluation difference calculation unit 105 calculates the evaluation reference value E_{Gj} of the group Gⱼ in the same manner.

Then, the cumulative fairness evaluation difference calculation unit 105 calculates the difference of the fairness evaluation functions by using the following equation (5) diff. The difference diff of the fairness evaluation function represents a difference between the fairness evaluation values of the groups.

[Equation 4]

diffᵢⱼ=E_{G}_{ᵢ}−E_{G}_{ⱼ} EQUATION (5)

Difference in Fairness Evaluation Function diff corresponds to a value of fairness based on the attribute of the first rank.

Difference in Fairness Evaluation Function diff is the difference between the evaluation reference value E G_{I} of the group G_{I} (the first evaluation value indicating the fairness of the first attribute based on the first rank) and the evaluation reference value E_{Gj} of the group Gⱼ (the second evaluation value indicating the fairness of the second attribute based on the first rank).

In addition, the cumulative fairness evaluation difference calculation unit 105 may calculate the difference diff between the fairness evaluation functions using an area under the curve (AUC) that is a pairwise evaluation reference value.

The AUC is represented by the following formula:

AUC=P(ŷᵢ>ŷⱼ|yᵢ>yⱼ)

A_{G}_{ᵢ}_{>G}_{ⱼ}=P(ŷᵢ>ŷⱼ|yᵢ>yⱼ,i∈Gᵢ,j∈Gⱼ) [Equation 5]
yᵢ∈{0,1}OBSERVATION LABEL (0: NEGATIVE EXAMPLES, 1: POSITIVE EXAMPLES) IN EXAMPLE i
ŷᵢ∈[0,1]: PREDICTION SCORES (DETERMINED TO BE A POSITIVE EXAMPLE HIGHER THE PROBABILITY) IN EXAMPLE i
Gᵢ: PROTECTION GROUP TO WHICH EXAMPLE i BELONGS

Then, the cumulative fairness evaluation difference calculation unit 105 calculates a difference diff between the fairness evaluation functions using, for example, the following equation (6). The difference diff of the fairness evaluation function represents a difference between the fairness evaluation values of the groups.

[Equation 6]

diffᵢⱼ=A_{G}_{ᵢ}_{>G}_{ⱼ}−A_{G}_{ⱼ}_{>G}_{ᵢ} EQUATION (6)

Then, the cumulative fairness evaluation difference calculation unit 105 calculates cumulative fairness evaluation differences cᵢⱼ and cⱼᵢ based on the following equations (7) and (8) by using the calculated difference of the fairness evaluation function diff. The cumulative fairness evaluation differences cᵢⱼ and cⱼᵢ are values obtained by accumulating diffᵢⱼ and diffⱼᵢ by simple iteration. The cumulative fairness evaluation difference may be referred to as a cumulative fairness value.

The cumulative fairness evaluation difference calculation unit 105 estimates a cumulative fairness evaluation difference cᵢⱼ using an update equation described in the following equation (7) that uses the learning rate n.

[Equation 7]

cᵢⱼ^{t+1}←cᵢⱼ^{t}−η·diffᵢⱼ EQUATION(7)
cᵢⱼ^{t}: DIFFERENCE IN FAIRNESS EVALUATION FUNCTION ACCUMULATED UP TO TRAINING STEP t (CUMULATIVE FAIRNESS EVALUATION DIFFERENCE)
diffᵢⱼ: DIFFERENCES IN FAIRNESS EVALUATION FUNCTION AT PRESENT
η>0: PARAMETER FOR CONTROLLING STEP WIDTH

The value of the cumulative fairness evaluation difference calculated by the cumulative fairness evaluation difference calculation unit 105 is stored in, for example, a predetermined storage area in the memory 12 or the storage device 13.

The weight calculation unit 106 sets a weight for each group pair. The weight of the pair (l, j) is denoted as weight wij.

The weight calculation unit 106 calculates a swap (swap) variable. The swap variable indicates group fairness that is varied by swapping (optimizing) pairs. Even in the same group pair, swap changes depending on the position of ranking.

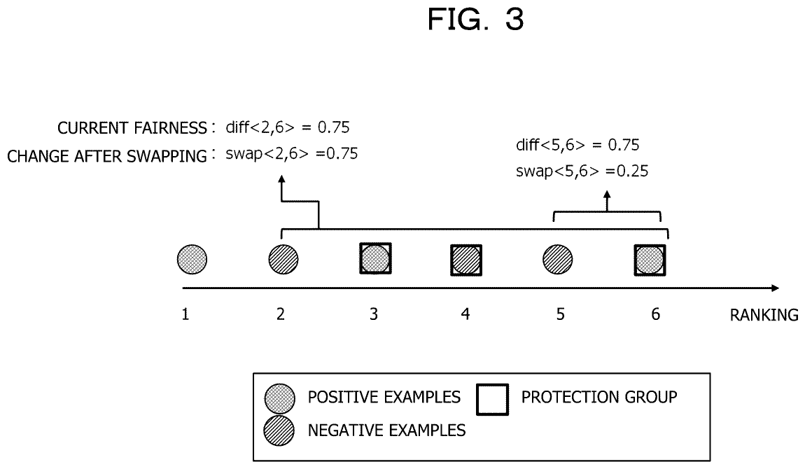

FIG. 3 is a diagram for explaining swap variables in the information processing apparatus 1 as an example of the embodiment.

In the example illustrated in FIG. 3, each shaded circle represents a positive example or a negative example, and indicates ranking of each example. Also, in the figure, a circle surrounded by a square indicates that it belongs to a protection group. In addition, a circle not surrounded by a square indicates that it belongs to a unprotected group.

In the example illustrated in FIG. 3, the difference (diff) in the group fairness (may be referred to as “pairwise fairness”) between the positive example and the negative example is 0.75 (diff=0.75). In order to achieve fairness, we want this diff to be 0.

Consider performing corrective processing by exchanging (optimizing the order of) a positive example of a protected group and a negative example of a non-protected group. In the example illustrated in FIG. 3, two pairs) <2, 6> and <5, 6> are considered as candidates for exchange, respectively.

When <2, 6> are exchanged, diff <2, 6> after conversion becomes 0, and the fairness becomes ideal.

When <5, 6> are exchanged, diff <5, 6> after conversion becomes 0.5, and fairness is still not achieved.

The difference “diff” in the group fairness between before and after swapping group pair rankings may be referred to as the swap variable.

The swap variable swap <2,6> in the example of <2,6> e.g., above is 0.75 (=0.75−0). The swap variable swap <5, 6> in the above example of <5, 6> is 0.25 (=0.75−0.5).

The swap variable is a parameter based on the difference between the value of fairness based on the attribute of the second rank after the ranks of the first data of the protected group (first attribute) and the second data of the unprotected group (second attribute) among the plurality of data are swapped and the value of fairness based on the attribute of the first rank (predicted ranking) diff.

The swap variable represents the importance of the pair according to the rate of change of fairness after swapping. Then, the weight calculation unit 106 calculates a swap variable for each pair.

The weight calculation unit 106 calculates the weight wⱼᵢ based on cᵢⱼ. The weight wᵢⱼ is expressed by the following equation (8). That is, the weight wᵢⱼ is proportional to a probability distribution having swapᵢⱼ×cᵢⱼ as an argument.

wᵢⱼ∝p(swapᵢⱼ×cᵢⱼ) (8)

The weight calculation unit 106 may calculate the weight w using, for example, a sigmoid function πᵢⱼ. That is, the weight calculation unit 106 may calculate the weight wᵢⱼ according to the following equation (9).

wᵢⱼ=σ(swapᵢⱼ×cᵢⱼ) (9)

Note that σ(x) is a function for converting the argument x into a range of [0,1], and is a function for randomizing a variable. Σ(x) is expressed by, for example, the following equation.

σ(x)=1/(1+e^{-x})

The weight calculation unit 106 calculates a weight in which swap and the difference between the fairness evaluation functions are reflected.

The weighted loss function calculation unit 107 calculates a weighted loss function Loss represented by the following equation (10) using the weight wᵢⱼ calculated by the weight calculation unit 106.

$$[ Equation 8 ]$$

$$Loss = - {\sum }_{( {y}_{i} , {y}_{j} ) ∈ {D}_{biased}} {w}_{ij} P ( {\hat{y}}_{i} > {\hat{y}}_{j} \vert {y}_{i} > {y}_{j} ) \qquad EQUATION ( 10 )$$

In the loss function described in equation (10) above, the weight is multiplied by the accuracy loss.

That is, the weighted loss function calculation unit 107 calculates an error (accuracy loss) of the prediction ranking and accumulates a value obtained by multiplying the error by a weight to calculate a weighted loss function Loss.

Weighted Loss Function Loss (loss function) includes a cumulative fairness value obtained by cumulatively processing a value of fairness based on an attribute calculated based on a rank of data according to an output of a machine learning model for each step of training.

The model parameter calculation unit 108 updates each parameter of the machine learning model used by the prediction score calculation unit 103 by using the weighted loss function Loss generated (calculated) by the weighted loss function creation unit 104 (the weighted loss function calculation unit 107. The model parameter calculation unit 108 calculates each parameter of the machine learning model by the gradient descent method using the weighted loss function Loss. The calculated parameters are reflected in the machine learning model used by the prediction score calculation unit 103.

In the loss function described in equation (10) above, cᵢⱼ is increased if diff; <0, i.e., if group G_{I} is more disadvantaged than group Gⱼ.

This increases the weight wᵢⱼ and increases the loss for items in G_{I}. As a result, in the machine learning, learning is performed so that the item of the group G_{I} becomes higher.

If on the other hand diffᵢⱼ>0, i.e. group G_{I} is treated more favorably than group Gⱼ, cᵢⱼ is decreased.

This reduces the weight wᵢⱼ and reduces the loss for items in G_{I}. As a result, in the machine learning, learning is performed so that the item of the group G_{I} becomes lower.

In this way, the model parameter calculation unit 108 updates the parameters of the machine learning model using the weighted loss function Loss, and thus the machine learning model learns to place an item with a larger loss at a higher position.

(B) Operation

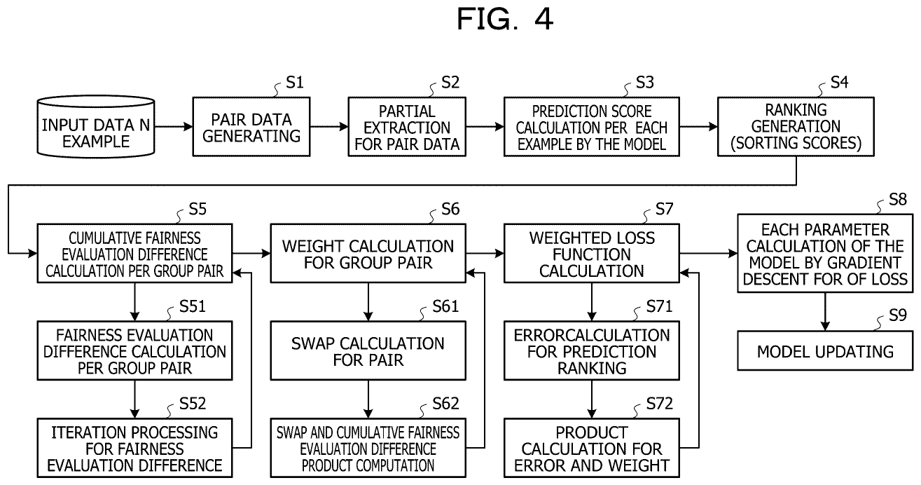

Processing in the information processing apparatus 1 as an example of the embodiment configured as described above will be described with reference to a flowchart illustrated in FIG. 4.

Initialization by the weighted loss function creation unit 104 is executed in advance, for example, a training step t=0, η=10, and cᵢⱼ=0 are set.

In the S1, the pair data generating unit 101 generates a plurality of pairs of positive examples and negative examples by using the input binary values. The pair data creation unit 101 creates pair data of all combinations of positive examples and negative examples.

In the S2, when the number of pair data created by the pair data creation unit 101 is large and the number of pair data is equal to or larger than a predetermined value, the prediction score calculation unit 103 extracts a predetermined number of pair data. When the number of pairs is less than the predetermined number, the process may be skipped and the process may proceed to S3.

In S3, the prediction score calculation unit 103 inputs each example of the input dataset to the machine learning model and calculates a prediction score for the label {0,1}.

In the S4, the ranking generator 102 sorts the prediction scores of the examples calculated by the prediction score calculation unit 103 to create a descending list of the prediction scores of the examples.

In the S5, the cumulative fairness evaluation difference calculation unit 105 calculates a cumulative fairness evaluation difference based on the predicted ranking set by the ranking generation unit 102.

The cumulative fairness evaluation difference calculation unit 105 calculates the fairness evaluation difference (diff) for each group pair when calculating the cumulative fairness evaluation difference (S51). Then, the cumulative fairness evaluation difference calculation unit 105 calculates a cumulative fairness evaluation difference by accumulating the calculated fairness evaluation difference (diff) by iteration (S52).

For example, in the predictive ranking illustrated in FIG. 2, when the evaluation reference value E_{Gi} of the group G_{I} is 0.58 (E_{Gi}≈0.58 and the evaluation reference value E_{Gj} of the group Gⱼ is 0.33 (E_{Gj}≈0.33), the difference diffᵢⱼ between the fairness evaluation functions of the group pair (G_{I}, Gⱼ) is obtained as follows.

diffᵢⱼ=E_{G}_{ᵢ}−E_{G}_{ⱼ}≈0.25 [Equation 9]

The cumulative fairness evaluation difference calculation unit 105 calculates the cumulative fairness evaluation differences cᵢⱼ and cⱼᵢ, based on the difference of the fairness evaluation function diff u and the above equation (7).

cᵢⱼ=cᵢⱼ−η·diffᵢⱼ=0−10·0.25=−2.5

cⱼᵢ=cⱼᵢ−η·diffⱼᵢ=0+10·0.25=2.5 [Expression 10]

In the S6, the weight calculation unit 106 sets a weight for each group pair.

When calculating the weight, the weight calculation unit 106 calculates swap (swap) for each pair (S61), and calculates the weight w u based on the product of the calculated swap (swap) and the cumulative fairness evaluation difference cᵢⱼ(S62). It is desirable that the weight calculation unit 106 consider only a pair of a positive example and a negative example.

For example, an example of calculating a weight in the predictive ranking illustrated in FIG. 2 will be described. In the examples described below, subscripts of numbers 1 to 4 represent rankings. Swap₁₂=0, swap₁₄≈0.3, swap₃₂≈0.1, and swap₃₄=0.

Because wᵢⱼ=P (swapᵢⱼ×cᵢⱼ), the weight wᵢⱼ may be calculated, but in this example, an example using a sigmoid function 6 is described.

For example, the weight calculation unit 106 calculates the weight wᵢⱼ by the following equation using the sigmoid function σ.

wiⱼ=σ(swapᵢⱼ×cᵢⱼ)

In the predictive ranking illustrated in FIG. 2, the calculated weights are described below.

w₁₂=σ(0×0)=0.5

w₁₄=σ{0.3×(−2.5)}≈0.32

w₃₂=σ(0.1×2.5)≈0.56

w₃₄=σ(0×0)=0.5

In the S7, the weighted loss function calculation unit 107 calculates the weighted loss function. When calculating the weighted loss function, the weighted loss function calculation unit 107 calculates errors (accuracy loss) of each predicted ranking (S71) and multiplies the errors by corresponding weights (S72). Then, the weighted loss function calculation unit 107 calculates a weighted loss function Loss by accumulating the product of the error and the weight.

The error of the predicted ranking is represented by, for example, the following equation.

ERROR−P(ŷᵢ>ŷⱼ|yᵢ>yⱼ)=−Inσ(ŷᵢ>ŷⱼ|yᵢ>yⱼ)=Pᵢⱼ [Expression 11]

Various known methods may be used to calculate the error. In this example, the logarithm Inx=log ex is calculated after first making a probability with σ(x). The use of logarithms is for general reasons to simplify the calculation of gradients.

The weighted loss function calculation unit 107 calculates a weighted loss function using the above equation (10).

Loss=0.5×0.59+0.32×0.37+0.56×0.85 0.5×0.55≈1.1

Thereafter, in the S8, the model parameter calculation unit 108 calculates each parameter of the machine learning model used by the prediction score calculation unit 103 by using the weighted loss function Loss generated (calculated) by the weighted loss function creation unit 104 (the weighted loss function calculation unit 107.

In the S9, the model parameter calculation unit 108 uses the calculated parameters to update the machine learning model used by the prediction score calculation unit 103. Thereafter, the process is terminated.

(C) Effect

As described above, according to the information processing apparatus 1 as an embodiment of the present invention, the weight calculation unit 106 calculates the swap variable in the case where the order of the positive example of the protection group and the negative example of the unprotected group is switched, and the weighted loss function calculation unit 107 calculates the loss function reflecting the swap variable as the weight. At this time, the weight estimation is performed by directly using the fairness constraint without approximation.

Then, each parameter of the machine learning model is updated using the loss function calculated in this way. This makes it possible to accurately detect group fairness regardless of the number of pieces of data.

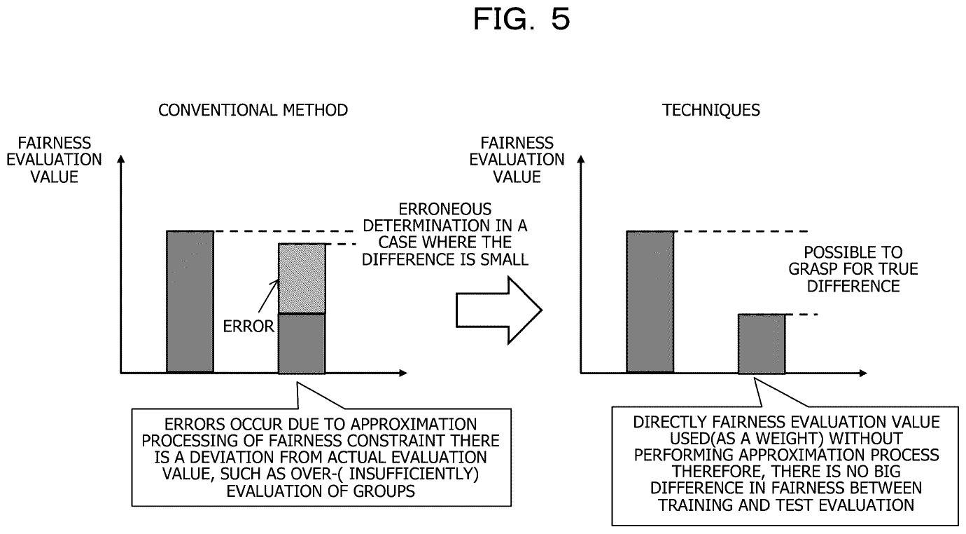

FIG. 5 is a diagram illustrating a fairness evaluation value by the information processing apparatus 1 as an example of the embodiment in comparison with a conventional method.

In the conventional method, since the approximation process is performed on the fairness constraint in the loss function (see equation (1)), an error occurs due to the approximation process. As a result, separation from the actual evaluation value occurs, for example, a certain group is excessively (insufficiently) evaluated.

On the other hand, in the information processing apparatus 1, the fairness evaluation value is directly used as the weight without performing the approximation process in the loss function. Therefore, there is no large difference in fairness between the training of the machine learning model and the test evaluation.

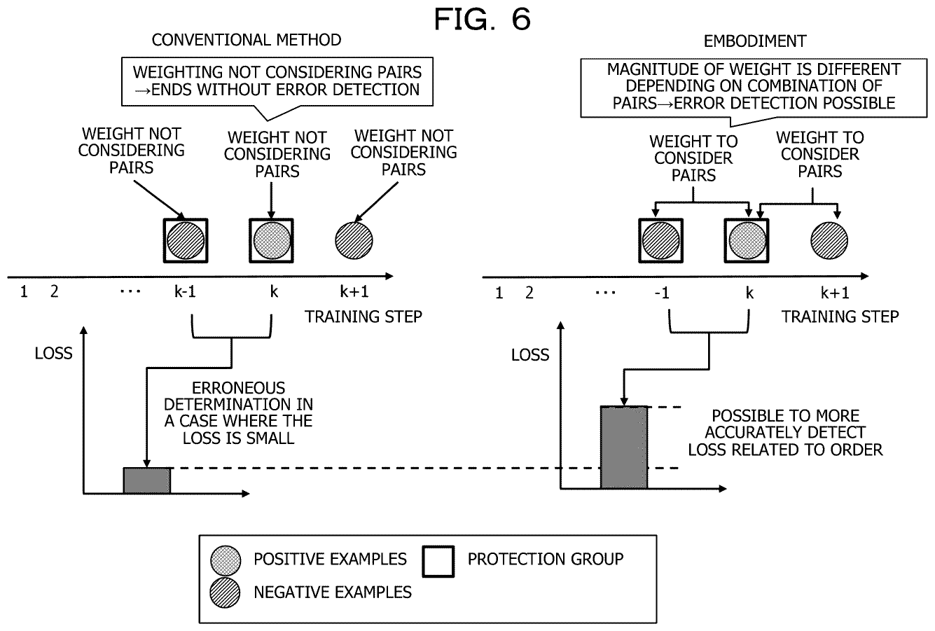

FIG. 6 is a diagram illustrating a fairness correction method by the information processing apparatus 1 as an example of the embodiment in comparison with a method that does not consider a pair.

In the loss function in the conventional method described in the above-described equation (1), it is conceivable to perform the fairness correction processing by weighting the loss with a weight according to the Boltzmann distribution with the fairness constraint as an argument without performing the approximation processing. The probability distribution according to the exponential family of fairness constraints is used as the weights.

However, in such a method, since the pair is not considered, an erroneous determination occurs in a case where the loss is small in the course of the training step, and the training of the machine learning model ends without error detection.

On the other hand, in the information processing apparatus 1, the weight calculation unit 106 sets a weight for each group pair. Since the magnitude of the weight is different depending on the combination of the pairs, it is possible to more accurately detect the loss related to the order in the course of the training step the error detection can be performed.

The weight calculation unit 106 sets a weight in consideration of the swap variable for each pair (order) and varies the weight according to the combination of the pair, thereby optimizing the pair.

Further, in the information processing apparatus 1, by performing weighting in consideration of the pair (order), it is possible to correct the fairness of ranking by weighting. Pair (order) unfairness can be detected and rectified.

(D) Others

FIG. 7 is a diagram illustrating a hardware configuration of the information processing apparatus 1 as an example of the embodiment.

The information processing apparatus 1 is a computer, and includes, for example, a processor 11, a memory 12, a storage device 13, a graphic processing device 14, an input interface 15, an optical drive device 16, a device connection interface 17, and a network interface 18 as components. These components 11 to 18 are configured to be able to communicate with each other via a bus 19.

The processor (controller) 11 controls the entire information processing apparatus 1. The processor 11 may be a multiprocessor. The processor 11 may be, for example, any one of a CPU, a micro processing unit (MPU), a digital signal processor (DSP), an application specific integrated circuit (ASIC), a programmable logic device (PLD), and a field programmable gate array (FPGA). In addition, the processor 11 may be a combination of two or more types of elements among a CPU, an MPU, a DSP, an ASIC, a PLD, and an FPGA.

When the processor 11 executes a control program (machine learning program, not illustrated), the functions as the pair data creation unit 101, the ranking generation unit 102, the prediction score calculation unit 103, the weighted loss function creation unit 104, and the model parameter calculation unit 108 illustrated in FIG. 1 are realized.

The information processing apparatus 1 realizes functions as the pair data creation unit 101, the ranking generation unit 102, the prediction score calculation unit 103, the weighted loss function creation unit 104, and the model parameter calculation unit 108 by executing, for example, a program (machine learning program, OS program) recorded in a computer-readable non-transitory recording medium.

The program describing the processing contents to be executed by the information processing apparatus 1 can be recorded in various recording media. For example, a program to be executed by the information processing apparatus 1 may be stored in the storage device 13. The processor 11 loads at least a part of the program in the storage device 13 into the memory 12 and executes the loaded program.

The program to be executed by the information processing system 1 (processor 11) may be recorded in non-transitory portable recording media such as an optical disc 16a, a memory device 17a, and a memory card 17c. The program stored in the portable recording medium becomes executable after being installed in the storage device 13 under the control of the processor 11, for example. Alternatively, the processor 11 may read the program directly from the portable recording medium and execute the program.

The memory 12 is a storage memory including a ROM (Read Only Memory) and a RAM (Random Access Memory. The RAM of the memory 12 is used as a main storage device of the information processing apparatus 1. At least a part of the program to be executed by the processor 11 is temporarily stored in the RAM. The memory 12 also stores various types of data required for processing by the processor 11.

The storage device 13 is a storage device such as a hard disk drive (HDD), a solid state drive (SSD), or a storage class memory (SCM), and stores various data.

The storage device 13 stores an OS program, a control program, and various data. The control program includes a machine learning program.

Note that a semiconductor storage device such as an SCM or a flash memory may be used as the auxiliary storage device. RAID (Redundant Arrays of Inexpensive Disks) may be configured by using a plurality of storage devices 13.

The storage device 13 or the memory 12 may store calculation results generated by the pair data creation unit 101, the ranking generation unit 102, the prediction score calculation unit 103, the weighted loss function creation unit 104, and the model parameter calculation unit 108, various data to be used, and the like.

A monitor 14a is connected to the graphics processor 14. The graphic processing device 14 displays an image on the screen of the monitor 14a in accordance with an instruction from the processor 11. Examples of the monitor 14a include a display apparatus using a cathode ray tube (CRT), a liquid crystal display apparatus, and the like.

A keyboard 15a and a mouse 15b are connected to the input interface 15. The input interface 15 transmits signals sent from the keyboard 15a and the mouse 15b to the processor 11. Note that the mouse 15b is an example of a pointing device, and other pointing devices may be used. Examples of other pointing devices include a touch panel, a tablet, a touch pad, and a track ball.

The optical drive device 16 reads information recorded on the optical disc 16a using a laser beam or the like. The optical disc 16a is a portable non-transitory recording media on which information is recorded so as to be readable by reflection of light. Examples of the optical disc 16a include DVDs (Digital Versatile Discs), DVD-RAM, CD-ROM (Compact Disc Read Only Memory), CD-R (Recordable)/RW (ReWritable), and the like.

The device connection interface 17 is a communication interface for connecting a peripheral device to the information processing apparatus 1. For example, a memory device 17a and a memory reader/writer 17b can be connected to the device connection interface 17. The memory device 17a is a non-transitory recording media having a function of communicating with the device connection interface 17. The memory reader/writer 17b performs writing to the memory card 17c or reading from the memory card 17c. The memory card 17c is a card-type non-transitory recording media.

The network interface 18 is connected to a network. The network interface 18 transmits and receives data via a network. Other information processing apparatuses, communication devices, and the like may be connected to the network.

The disclosed technology is not limited to the above-described embodiments, and various modifications can be made without departing from the spirit of the embodiments. Each configuration and each process of the present embodiment can be selected as necessary, or may be appropriately combined.

In addition, it is possible for those skilled in the art to implement and manufacture the present embodiment based on the above disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing an information processing program that causes at least one computer to execute processing, the processing comprising:
specifying a first order of a rank in a plurality of pieces of data that is descending order of an output of a machine learning model, the output being an impact of the plurality of pieces of data on a certain event;
specifying a second order by interchanging the rank of first data that includes a first value of a binary parameter and second data that includes a second value of the binary parameter among the plurality of pieces of data in the first order, the first data being opposite to the second data of a positive example or negative example for the output, a difference of a value of function after interchanging being less than a value of function before interchanging;
acquiring a parameter weighted based on the second order; and
training the machine learning model by using a loss function including the parameters.

2. The non-transitory computer-readable storage medium according to claim 1, wherein
the value of the function before interchanging is based on the rank of the first data or the second data in the first order and the impact on the certain event of the binary parameter.

3. The non-transitory computer-readable storage medium according to claim 1, wherein
the loss function includes a cumulative value obtained by cumulatively processing a value of the function based on the binary parameter calculated based on a rank of data according to the output of the machine learning model for each step of the training.

4. The non-transitory computer-readable storage medium according to claim 1, wherein
the loss function is a weighted loss function obtained by multiplying a precision loss by a weight including the parameter and the cumulative fairness value.

5. The non-transitory computer-readable storage medium according to claim 1, wherein the processing further comprising
estimating a third order of the rank in a second plurality of pieces of data by inputting the second plurality of pieces of data to the trained machine learning model.

6. A machine learning method implemented by a computer, the machine learning method comprising:
specifying a first order of a rank in a plurality of pieces of data that is descending order of an output of a machine learning model, the output being an impact of the plurality of pieces of data on a certain event;
specifying a second order by interchanging the rank of first data that includes a first value of a binary parameter and second data that includes a second value of the binary parameter among the plurality of pieces of data in the first order, the first data being opposite to the second data of a positive example or negative example for the output, a difference of a value of function after interchanging being less than a value of function before interchanging;
acquiring a parameter weighted based on the second order; and
training the machine learning model by using a loss function including the parameters.

7. The machine learning method according to claim 6, wherein
the value of the function before interchanging is based on the rank of the first data or the second data in the first order and the impact on the certain event of the binary parameter.

8. The machine learning method according to claim 6, wherein
the loss function includes a cumulative value obtained by cumulatively processing a value of the function based on the binary parameter calculated based on a rank of data according to the output of the machine learning model for each step of the training.

9. The machine learning method according to claim 6, wherein
the loss function is a weighted loss function obtained by multiplying a precision loss by a weight including the parameter and the cumulative fairness value.

10. The machine learning method according to claim 6, wherein the method further comprising
estimating a third order of the rank in a second plurality of pieces of data by inputting the second plurality of pieces of data to the trained machine learning model.

11. A machine learning device comprising:
one or more memories; and
one or more processors coupled to the one or more memories, the one or more processors being configured to:
specify a first order of a rank in a plurality of pieces of data that is descending order of an output of a machine learning model, the output being an impact of the plurality of pieces of data on a certain event;
specify a second order by interchanging the rank of first data that includes a first value of a binary parameter and second data that includes a second value of the binary parameter among the plurality of pieces of data in the first order, the first data being opposite to the second data of a positive example or negative example for the output, a difference of a value of function after interchanging being less than a value of function before interchanging;
acquire a parameter weighted based on the second order; and
train the machine learning model by using a loss function including the parameters.
